(19) United States
(12) Patent Application Publication
(10) Pub. No.: US 2026/0305521 A1
(43) Pub. Date: Oct. 8, 2026

(54) Flow Device for at Least Partially Guiding a Conveyed Material Flow, Distributor Head for an Agricultural Spreading Machine and Agricultural Spreading Machine

(71) Applicant: Amazonen-Werke H. Dreyer SE & CO. KG, Hasbergen (DE)

(72) Inventors: Jan Philipp RADEKE, Bassum (DE); Thomas WIEN, Stuhr (DE)

(73) Assignee: Amazonen-Werke H. Dreyer SE & CO. KG, Hasbergen (DE)

(21) Appl. No.: 18/996,638

(22) PCT Filed: Jun. 6, 2023
(86) PCT No.: PCT/EP2023/065030

§ 371 Date: Jan. 17, 2025

(30) Foreign Application Priority Data
Jul. 21, 2022 (DE) 10 2022 118 253.3

(51) Int. Cl. A01C 7/08

(52) U.S. Cl. CPC A01C 7/084

(57) ABSTRACT

The disclosure relates to a flow device for at least partially guiding a conveyed material flow within a distributor head of an agricultural spreading machine, wherein the flow device is configured to generate an at least partially rotating or an at least partially helical conveyed material flow. Furthermore, the disclosure relates to a distributor head for an agricultural spreading machine and for distributing granular material to a plurality of spreading lines and an agricultural spreading machine.

### CROSS REFERENCE TO RELATED APPLICATIONS

The present application claims priority under 35 U.S.C. § 365 to PCT/EP 2023/065030 filed on Jun. 6, 2023 and under 35 U.S.C. § 119(a) to German Application No. 10 2022 118 253.3 filed on Jul. 21, 2022, both of which are incorporate by reference in their entireties.

### BACKGROUND

The disclosure relates to a flow device for at least partially guiding a conveyed material flow within a distributor head and to a distributor head for an agricultural spreading machine. The disclosure also relates to an agricultural spreading machine with a distributor head.

Agricultural spreading machines, such as sowing machines, usually use a distributor for granular material, such as seeds, fertilizers and the like. Such a distributor is referred to as a distributor head.

A distributor head is usually connected on the input side to a pneumatically supplied supply line. On the output side, the distributor head comprises several evenly distributed output channels, each of which is connected to one end of a spreading line. The other ends of the spreading lines are connected to the storage devices of the agricultural spreading machine. By means of the depositing devices, which can be, for example, sowing coulters, the granular material is deposited on an agricultural utilizable area (see, for example, DE 10 2008 050 735 A1).

### SUMMARY

Against this background, it was found that the even distribution of granular material from the distributor head into the output channels and thus into the spreading lines when a spreading machine is traveling on an agricultural area with an inclination cannot be ensured.

It is therefore the object of the present disclosure to distribute granular material evenly in the distributor head, even if the distributor head is inclined or is used on an agricultural area with a slope.

A first aspect of the present disclosure comprises a flow device for at least partially guiding a conveyed material flow within a distributor head of an agricultural spreading machine.

The flow device is configured to generate an at least partially rotating or an at least partially helical conveyed material flow. Thus, the flow device can be configured to generate an at least partially rotating or an at least partially helical conveyed material flow from a flow of conveyed material flowing in an axial direction.

In other words, the flow device can be configured to at least partially rotate a conveyed material flow flowing in an axial direction, so that the conveyed material flow continues to flow in an axial direction, but also rotates. In this way, the flow device converts a conveyed material flow flowing in the axial direction into an at least partially rotating or at least partially helical conveyed material flow.

In other words, the flow device can be configured to add a flow component in the circumferential or tangential direction, a flow component in the axial direction and/or a flow component in the radial direction to a flowing conveyed material flow. The flow device can also be configured to generate a swirl flow at least partially from a conveyed material flow flowing in the axial direction. A swirl flow is a rotationally symmetrical flow with a flow component in the circumferential direction. In the case of a swirling flow, e.g. in a pipe, a flow component in the axial direction is also present in addition to the flow component in the circumferential direction. The flowing conveyed material or granular material of the conveyed material flow then moves along one or more helical paths. Within a certain pipe length, the conveyed material covers a greater distance along the pipe wall compared to a swirl-free flow at the same flow velocity. Due to the rotation or helical movement of the conveyed material flow, accumulations of granular material, which can occur when a distributor head is inclined on an inclined utilizable area, can be avoided within the distributor head for an agricultural spreading machine and for spreading granular material.

In the present application, a conveyed material flow may comprise air and granular material. Further, a conveyed material flow may flow in an axial direction and/or flow in an axial direction of or towards the flow device. For example, the conveyed material flow can also impinge on the flow device, e.g. in an axial direction, and interact with it.

In addition, the flow device can extend in an axial direction, in a radial direction and in a circumferential direction or in a tangential direction to form a spatial body.

Furthermore, the flow device can divide a conveyed material flow, for example when flowing through the flow device, into an inner section and an outer section. The outer section may completely surround the inner section so that the outer section contacts or interacts with the flow device and the inner section contacts or interacts with the outer section.

Further, the outer section may mimic a hollow cylindrical shape and the inner section may mimic a cylindrical shape, wherein the inner cylindrical section completely fills the outer hollow cylindrical section. Thus, the flow device contacts the outer section and the inner section contacts the outer section. The interaction between the flow device and the conveyed material flow or between the flow device and an outer section of the conveyed material flow allows an at least partially rotating or at least partially helical conveyed material flow to be generated. This allows avoiding accumulations of granular material, which can occur when a distributor head is inclined on an inclined utilizable area, within the distributor head for an agricultural spreading machine and for distributing the granular material.

Furthermore, the flow device may comprise at least one flow guide for generating an at least partially rotating or an at least partially helical conveyed material flow. In other words, the flow device may comprise at least one flow guide for at least partially diverting or rotating a conveyed material flow and/or for diverting and rotating at least an outer section of a conveyed material flow.

Here, the at least one flow guide can be configured to act on a conveyed material flow from the outside or exclusively from the outside in order to add a movement component or flow component in the tangential direction and/or in the radial direction and/or in the axial direction to at least one outer section of the conveyed material flow, which completely surrounds an inner section of a conveyed material flow. Furthermore, the outer section and/or the inner section of a conveyed material flow can be oriented in the same direction as an axial direction of the flow device. Thus, an at least partially helical or an at least partially rotating conveyed material flow can be generated.

Furthermore, the at least one flow guide can be configured to be adjustable. In this way, different flow speeds and/or different characteristics of a conveyed material flow can be taken into account. An at least partially helical or an at least partially rotating conveyed material flow can be generated. The at least one flow guide can be rotatable or rotatable about an axis in order to realize different angles of attack of the at least one flow guide with respect to a conveyed material flow. The flow device or a distributor head comprising the flow device can also be equipped with an inclination detection system in order to detect the inclination of an agricultural utilizable area. Depending on the detected inclination, a control system can change the angle of attack in such a way that the angle of attack is adjusted as the inclination increases in order to achieve a more strongly developed helical conveyed material flow. Conversely, as the inclination decreases, the angle of attack can be adjusted by the control system so that there is little or no helical or rotating conveyed material flow.

In aerodynamics, the angle of attack, also known as the angle of incidence, is an angle between the direction of the incoming fluid or conveyed material flow and the chord of a profile or the at least one flow guide. The profile can, for example, be configured similar to a part of an airfoil, a rotor blade, a sail, a turbine blade or similar to a part of at least one flow guide.

The at least one flow guide may comprise an elastic material, such as elastomer, and/or plastic and/or steel, such as stainless steel, for example, in order to respond to the expected wear and/or, for example, to minimize wear when using a fertilizer as granular material.

Furthermore, the at least one flow guide can be configured as a flow body to be flowed around or as a flow section to be flowed through in order to at least partially form a rotating or helical conveyed material flow.

Furthermore, the flow device can be configured in such a way that a conveyed material flow can be introduced into the flow device and/or that a conveyed material flow can flow through the flow device and/or that a conveyed material flow can flow onto the flow device. The introduction of the conveyed material flow into the flow device and/or the flow of the conveyed material flow through the flow device and/or the flow of the conveyed material flow towards the flow device can take place in the axial direction of the flow device or from the axial direction. Thus, the flow device can act in various ways on a conveyed material flow that strikes the flow device in the axial direction, for example to achieve a rotation or a helical movement of the conveyed material flow when it leaves the flow device.

The flow device can also comprise a wall. The wall can at least partially or completely surround the flow device. The walls can also be configured to be rotationally symmetrical or axially symmetrical. This facilitates manufacture and guarantees low costs.

Furthermore, the wall can form or continue at least a part of a wall of an inlet device of a distribution head of an agricultural spreading machine and/or at least a part of a wall of a main conveyor of a distribution head of an agricultural spreading machine and/or at least a part of a wall of a distribution device of a distribution head of an agricultural spreading machine. This allows the flow device to be mounted at a suitable and/or almost adjacent location within a distributor head in order to realize a rotation or a helical movement of the conveyed material flow.

The wall can also be configured in a tubular and/or hollow cylindrical shape. This makes the flow device cost-effective to manufacture.

Furthermore, the wall can form a tubular and/or hollow cylindrical sector, analogous to a circular sector. Accordingly, the wall can also form only sections or parts of a higher-level unit, such as a main conveyor of a distribution head. In this way, the flow device can be attached at any point within a distributor head in order to generate a rotating or helical movement of the conveyed material flow.

In addition, the wall can be configured with a wave-like shape in a cross-section along a direction in which a conveyed material flow flows against and/or through the flow device. The flow device can be configured to be wave-shaped in an axial direction. This can reduce the flow resistance within the flow device and direct the conveyed material flow in the desired direction.

In addition, it may be provided that the wall comprises at least one valley area and at least one hill area in a cross-section along a direction in which a conveyed material flow flows through or against the flow device or along the axial direction of the flow device. The at least one valley area and the at least one hill area can merge smoothly into one another, e.g. to simulate a so-called corrugated pipe.

Furthermore, the at least one flow guide can be configured similar to a guide vane or similar to a guide plate. As a result, an at least partially rotating or an at least partially helical conveyed material flow can be configured or generated. Both configurations can be used to guide a conveyed material flow. A guide vane can be configured like a guide vane of a jet engine. In this case, a guide vane is a blade that is stationary inside and on a housing or inside and on a wall of the flow device. A guide vane can be a guide surface with a curved shape or arranged at an angle inside a pipe or channel or inside and on a wall of the flow device in order to influence the direction of a fluid or conveyed material flow.

Alternatively or additionally, the at least one flow guide can be configured as a pin for guiding a conveyed material flow. As a result, an at least partially rotating or an at least partially helical conveyed material flow can be configured. The at least one flow guide configured as a pin can be cylindrical or frustoconical. The at least one flow guide configured as a pin can protrude from a wall of the flow device. Thus, the at least one flow guide can interact with the conveyed material flow or influence at least one outer section of the conveyed material flow, so that a helical or rotating conveyed material flow can be formed by means of it.

In addition, the at least one flow guide configured as a pin can enclose an angle of 90 degrees or an angle in the range between 80 and 100 degrees to the surface of a wall of the flow device. Within the said range, a helical conveyed material flow can be formed on the one hand and, on the other hand, the at least one flow guide can be configured to be mechanically robust and easily realized.

Alternatively or additionally, the at least one flow guide can be configured as a fluid channel within a wall of the flow device. As a result, an at least partially rotating or an at least partially helical conveyed material flow can be formed.

The at least one flow guide can be arranged within a wall of the flow device in order to add a movement component or flow component to the conveyed material flow in a tangential direction and/or in a radial direction and/or in an axial direction, e.g. relative to the flow device, by means of an air flow that flows through the at least one flow guide. This allows an at least partially rotating or an at least partially helical conveyed material flow to be formed.

For adding a movement component or flow component in the tangential direction and/or in the radial direction and/or in the axial direction, an air flow can be added to the conveyed material flow through the at least one flow guide and/or an air flow can be discharged through the at least one flow guide. This means that air can be blown in and/or extracted through the at least one flow guide.

The at least one flow guide can extend along a straight axis. This simplifies the production of the at least one flow guide within the wall.

The flow device can also comprise a wall. The wall can at least partially or completely surround the flow device.

The at least one flow guide can be arranged within the wall at an angle to the conveyed material flow or to an axial direction of the flow device.

Furthermore, it is conceivable that the at least one flow guide is arranged within the wall in a tangential direction and/or in a radial direction and/or in an axial direction of the flow device. Thus, the at least one flow guide can already be aligned or oriented similarly to the pitch of a thread, but also running in a radial direction, for example.

In addition, the at least one flow guide can include an angle of less than 90 degrees or an angle in the range between 20 and 60 degrees to the surface of the wall. Such an angle mimics the pitch of a thread, enabling the creation of an at least partially rotating or at least partially helical conveyed material flow.

Furthermore, the at least one flow guide can be fixed or adjustable or variably arranged on or in a wall of the flow device. In this way, the flow device can be optimally adjusted to the flow velocity of the conveyed material flow and to the conveyed material to be conveyed in order to generate an at least partially rotating or at least partially helical conveyed material flow. Different rotating or helical conveyed material flows can also be realized in order to be able to react to different changing inclinations of a spreading machine, for example.

Alternatively or additionally, it is also possible that the at least one flow guide is configured to be rotatable or variable relative to a wall of the flow device. In this case, the at least one flow guide can be rotatable or alignable or fixed in an angular range between 0 and 60 degrees to an axis that is aligned parallel to the conveyed material flow or parallel to an axial direction of the flow device. This means that the angle of attack of the at least one flow guide can be ideally adjusted to the flow velocity of the conveyed material flow and to the conveyed material to be conveyed, but also, for example, to the inclination of a distributor head in which the at least one flow guide can be arranged. This means that a stronger or weaker rotating or helical conveyed material flow can be set.

In addition, the at least one flow guide can be configured in a triangular shape. This allows a mechanically stable design and a fluid mechanically favorable configuration for generating an at least partially rotating or at least partially helical conveyed material flow.

The at least one flow guide can be configured similarly to a spherical triangle and/or with a changing thickness. In this way, fluid mechanical aspects can be taken into account when optimizing the flow within the flow device.

The at least one flow guide may comprise at least one first and at least one second flow guide. These can be configured differently.

This allows at least one first flow guide and at least one second flow guide to comprise different volumes and/or differently shaped surfaces and/or different angles of attack. By means of this configuration, the flow device or its at least one flow guide can be optimized.

Furthermore, the at least one first flow guide and the at least one second flow guide can comprise different angles of attack with respect to a conveyed material flow and/or with respect to an axial direction of the flow device. In this way, an at least partially rotating or at least partially helical conveyed material flow can be generated in a simple and effective manner, while at the same time achieving a low flow resistance.

In addition, the at least one first flow guide and the at least one second flow guide can be arranged one after the other in the direction of a conveyed material flow. This serves to improve the formation of a rotating or helical conveyed material flow.

At least two flow guides arranged one after the other in the direction of a conveyed material flow can be aligned with one another in such a way that, viewed in the direction of the conveyed material flow or in the axial direction of the flow device, at least one first flow guide and at least one second flow guide partially overlap or do not overlap at all.

Furthermore, at least one first flow guide and at least one second flow guide can be aligned mirror-inverted to each other.

In addition, at least two flow guides arranged one after the other in the direction of a conveyed material flow can be aligned with respect to one another in such a way that an edge of a first flow guide that is approached first is the shortest edge of the at least one first flow guide.

A first edge of at least one flow guide or the edge of the at least one first flow guide against which the flow flows first can also be aligned at a perpendicular angle or at an angle of between 81 and 99 degrees to a wall of the flow device.

A second edge of at least one flow guide or a flowed-on edge of the at least one second flow guide can be aligned at an angle of between 15 and 40 degrees to a wall of the flow device and can rise continuously from the wall or extend away from the wall in the direction of the conveyed material.

Furthermore, the flow device may comprise a first and/or a second ring of flow guides and/or a plurality of rings of flow guides. A ring may also be referred to as a circular ring arrangement.

In addition, it is possible that the first and/or second ring is configured in a cylindrical shape and comprises a plurality of flow guides. In this case, the flow guides can be arranged equally distributed in the circumferential direction of the ring and/or aligned in the same spatial orientation.

However, it is also conceivable that the flow guides are irregularly distributed in the circumferential direction of the ring.

In this case, the first ring can comprise at least one first flow guide and the second ring at least one second flow guide.

It may also be provided that the first and second rings are arranged one behind the other in the direction of a conveyed material flow or in the axial direction of the flow device.

The first and second rings can also be arranged offset to each other. For example, the first and second rings can be arranged offset to each other in such a way that the end of a first flow guide of the first ring arranged in the direction of a conveyed material flow or the end of a first flow guide of the second ring arranged in the axial direction of the flow device is arranged between two beginnings of two second flow guides of the second ring. This allows the effective conversion of a conveyed material flow flowing in the axial direction of the flow device into an at least partially rotating or at least partially helical conveyed material flow.

Furthermore, the first and second rings can be arranged offset to each other in such a way that a first flow guide of the first ring is arranged in the direction of a conveyed material flow between two second flow guides of the second ring. In this way, a conveyed material flow that flows in the axial direction of the flow device can be converted into an at least partially rotating or at least partially helical conveyed material flow.

Furthermore, the flow device can comprise a wall which, together with flow guides, forms the first and/or second ring.

The flow device can also be configured in a modular fashion so that at least two flow devices can be connected or detachably connected to each other. This allows simple fitting and easy installation of the flow device in an existing distribution head, for example.

The flow device may comprise at least one connecting section at which two flow devices are connectable to each other by material- and/or friction- and/or force-fit.

In addition, at least two connecting sections can be arranged distributed in the circumferential direction of the flow device in order to connect two flow devices to each other.

At least two connecting sections can also be arranged equally distributed in the circumferential direction of the flow device.

Furthermore, the flow device may comprise at least one connecting section at which the flow device is connectable in a material- and/or friction- and/or force-fit manner to a wall of a main conveyor of a distribution head of an agricultural spreading machine and/or to a wall of an inlet device of a distribution head of an agricultural spreading machine and/or to a wall of a distribution device of a distribution head of an agricultural spreading machine.

A second aspect of the present disclosure comprises a distributor head for an agricultural spreading machine and for distributing granular material to a plurality of spreading lines.

It is explicitly noted that the features of the flow device as mentioned in the first aspect may be applied to the distributor head individually or in combination with each other.

A distributor head for an agricultural spreading machine and for distributing granular material to several spreading lines comprises an inlet device for connection to a supply line of an agricultural spreading machine.

A conveyed material flow comprising air and granular material can be introduced into the distributor head or into a main conveyor of the distributor head through the supply line and/or through the inlet device. The supply line can be pneumatically pressurized in order to form a conveyed material flow.

The inlet device can comprise a constriction, configured as a nozzle, for example. This can be used to accelerate the conveyed material flow entering through the inlet device.

Furthermore, the distributor head comprises a main conveyor for further conveying the conveyed material flow from the inlet device to a distribution device of the distributor head.

In addition, the distributor head comprises a distribution device for distributing and/or forwarding the conveyed material flow into output channels of the distributor head. In this way, output channels leading from the distribution device can direct the conveyed material flow into spreading lines that lead to depositing devices.

Furthermore, it may be provided that the distribution device, the main conveyor and the inlet device are connected in series in the axial direction. The conveyed material flow can flow through the distribution device, the main conveyor and the inlet device in an axial direction.

In addition, the distributor head comprises at least one flow device for at least partially guiding the conveyed material flow according to the first aspect.

The at least one flow device can be arranged on the main conveyor. The at least one flow device can further form and/or continue the main conveyor.

The main conveyor can also be configured similarly to a diffuser. This can reduce the flow velocity of the conveyed material flow so that the safe formation of a helical or rotating flow of conveyed material can be ensured by means of at least one flow guide of the at least one flow device.

The at least one flow device can be attached to a wall of the main conveyor or continue the wall of the main conveyor. This ensures low resistance for the conveyed material flow,

The at least one flow device can be arranged downstream and/or upstream of the main conveyor.

The feature “downstream” and “upstream” refers to the conveyed material flow or its direction of flow.

The at least one flow device or its at least one flow guide can also be arranged on the inside of the main conveyor. Thus, a combined assembly can be realized, which simplifies the assembly of the distributor head. In other words, the at least one flow device can form at least part of the main conveyor.

Furthermore, the at least one flow device or its at least one flow guide can extend inwards from the inside of the main conveyor in a radial direction. Thus, the at least one flow device can exert an influence on the conveyed material flow in order to generate an at least partially rotating or at least partially helical conveyed material flow.

Furthermore, the at least one flow device can further form and/or continue a part of a wall of the main conveyor.

Furthermore, the at least one flow device can be arranged on the inlet device. In this case, the at least one flow device can be arranged downstream and/or upstream of the inlet device or arranged before and/or after the inlet device.

In addition, the at least one flow device or its at least one flow guide can be formed on the Inside of the inlet device. This enables the realization of a combined assembly, which simplifies the assembly of the distributor head. In other words, the at least one flow device can form at least part of the inlet device.

Also, the at least one flow device or its at least one flow guide may extend from the inside of the inlet device in a radial direction inwards. Thus, the at least one flow device can influence the conveyed material flow in order to generate an at least partially rotating or at least partially helical conveyed material flow.

Furthermore, the at least one flow device can further form and/or continue part of a wall of the inlet device. This ensures a low resistance for the conveyed material flow.

Furthermore, the at least one flow device can be arranged on the distribution device. In this case, the at least one flow device can be arranged upstream of the distribution device or arranged before the distribution device.

Furthermore, the at least one flow device or its at least one flow guide can be configured on the inside of the distribution device. In this way, a combined assembly can be realized, which simplifies the assembly of the distributor head. In other words, the at least one flow device can form at least part of the distribution device. Thus, a low resistance for the conveyed material flow can be ensured.

In addition, the at least one flow device or its at least one flow guide can extend inwards from the inside of the distribution device in a radial direction. In this way, the at least one flow device can influence the conveyed material flow in order to generate an at least partially rotating or at least partially helical conveyed material flow.

It may also be provided that the at least one flow device forms or continues part of a wall of the distribution device.

Furthermore, the at least one flow device can be configured to be immovable or movable. The at least one flow device can also be configured to be rotatable relative to the distribution device and/or the main conveyor and/or the inlet device. By means of the mobility or rotation of the at least one flow device, the formation or intensity of the at least partially helical or at least partially rotating conveyed material flow can be easily adjusted, for example. For example, a flow component in the tangential direction or in the circumferential direction of the conveyed material flow can be more pronounced with a flow device that is stationary or not rotating relative to a wall. On the other hand, a flow component in the tangential direction or in the circumferential direction may be less pronounced in the case of a flow device rotating freely relative to a wall. It is also possible that the at least one flow device is connected to a drive that drives the at least one flow device in order to set it in rotation. This can generate a more pronounced rotating or helical conveyed material flow.

Furthermore, the at least one flow device can be configured to rotate relative to an axis that is aligned parallel to the conveyed material flow or to a conveyed material direction or to an axial direction of the flow device and/or to an axial direction of the distributor head.

The at least one flow device can also be configured to be rigid or immovable. Thus, the at least one flow device can be configured to be relatively immovable relative to the distribution device and/or the main conveyor and/or the inlet device. This simplifies assembly and maintenance.

In addition, the distributor head can comprise three flow devices which are arranged one behind the other in the conveyed material flow or in the axial direction of the flow device and/or in the axial direction of the distributor head and together form and/or continue the main conveyor and/or the distribution device and/or the inlet device.

A first and second flow device can be arranged in the same orientation to one another. A third flow device can be aligned upside down in comparison to the first and second flow devices and arranged on the second and/or first flow device. This can simplify the attachment of several flow devices to further devices of the distributor head.

Furthermore, the distributor head can comprise at least one output channel or several output channels which extend from the distribution device and via which the conveyed material flow can be introduced into spreading lines leading to depositing devices. The at least one output channel or the output channels can extend in a radial direction from the distributor head.

The distributor head may comprise several return devices through which the conveyed material flow can be returned from an output channel to the main conveyor.

Furthermore, the distributor head can comprise a circulating return collecting area, which is connected to the main conveyor and into which all return devices open. The return collecting area can be arranged between the main conveyor and the inlet device or downstream of the inlet device. In the event that a flow device is arranged upstream of the inlet device, an at least partially rotating or at least partially helical conveyed material flow can be generated before the conveyed material flow enters the main conveyor. This makes it possible to avoid accumulations of granular material in the return collecting area and thus within the distributor head when the distributor head is inclined on an inclined utilizable area. Granular material can thus be easily picked up from the return collecting area and conveyed back in the direction of the distribution device.

Furthermore, the distributor head can comprise several return devices, each comprising a material return flow area and an air discharge flow area. The material return flow area can return the conveyed material flow or the granular material contained therein from an output channel to the main conveyor via a return flow. Air separated from a return flow can be fed through the air discharge flow area to an output channel and/or a spreading line.

In addition, the distributor head can comprise at least one deflecting device which can be brought into a through-passage position and/or a return position.

A position of the at least one deflecting device between the through-passage position and the return position can also be realized.

The at least one deflecting device can be arranged within a return device, so that in the through-passage position the conveyed material flow can be guided into an output channel of the distributor head and in the return position it can be guided into a material return flow area of the return device.

The at least one deflecting device may comprise a movable deflecting body.

A movable deflecting body of a deflecting device can be set up to block a passage from an output channel into the material return flow area in the through-passage position.

Alternatively or additionally, a movable deflecting body of a deflecting device can be set up to release the passage from an output channel into the material return flow area in the return position.

Any positions of the deflecting body between the through-passage position and the return position are also conceivable.

In addition, the deflecting body of a deflecting device can be set up to reduce or close the free flow cross-section in the passage from an output channel into the air discharge flow area in the through-passage position. Thus, the flow rate from an output channel to a spreading line can be variably adjusted.

A third aspect of the present disclosure comprises an agricultural spreading machine, such as a sowing machine.

It is expressly noted that the features of the distributor head as mentioned in the first aspect may be used individually or in combination with each other in the agricultural spreading machine.

Thus, an agricultural spreading machine, such as a sowing machine, comprises a distributor head according to the second aspect.

Here, the spreading machine may comprise a plurality of spreading lines for conveying granular material to an agricultural area. A spreading line may connect an output channel of the distributor head to a depositing device of the spreading machine.

Furthermore, the spreading machine can also comprise a plurality of depositing devices, each of which is connected to a spreading line of the spreading machine and is set up to deposit granular material onto an agricultural area.

Furthermore, the depositing devices and/or the distribution head and/or the spreading lines may be arranged on a machine frame of the spreading machine.

### BRIEF DESCRIPTION OF THE DRAWINGS

The disclosure is explained in more detail below with reference to embodiments in conjunction with associated drawings, which are described below.

FIG. 1 shows a machine group with a spreading machine in a perspective view;

FIG. 2 shows a perspective view of a distributor head of the spreading machine from FIG. 1;

FIG. 3 shows a sectional view of the distributor head from FIG. 2;

FIG. 4 shows a perspective view of the sectional view from FIG. 3;

FIG. 5 shows a partial perspective view of the distributor head from FIG. 2;

FIG. 6A-6D show four different views of a first embodiment of a flow device for at least partially guiding a conveyed material flow within the distributor head of FIG. 2;

FIGS. 7A-7D show four different views of a second embodiment of a flow device for at least partially guiding a conveyed material flow within the distributor head of FIG. 2; and

FIG. 8A-8B show two different views of a third embodiment of a flow device for at least partially guiding a conveyed material flow within the distributor head of FIG. 2.

### DETAILED DESCRIPTION

In the following description, the same reference signs are used for the same objects.

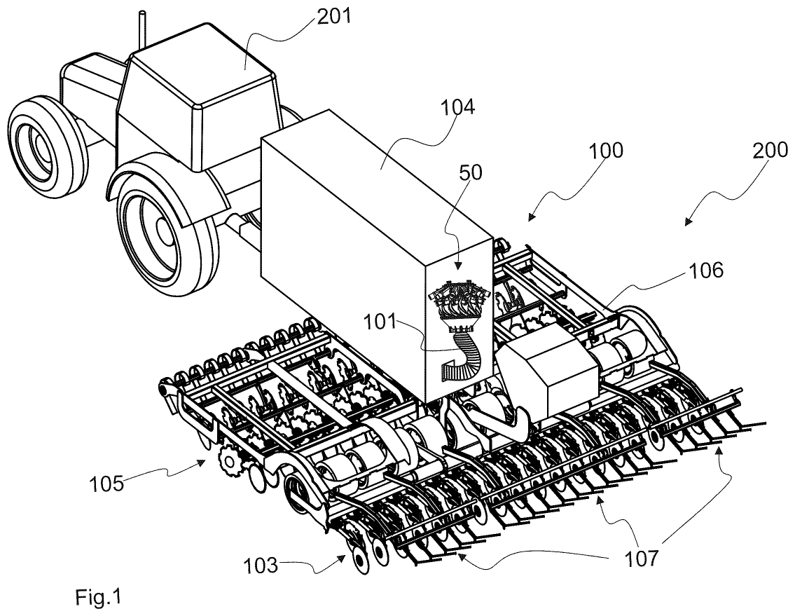

FIG. 1 shows a machine group 200 with a spreading machine 100 in a perspective view. More specifically, FIG. 1 shows an agricultural spreading machine 100, such as a sowing machine.

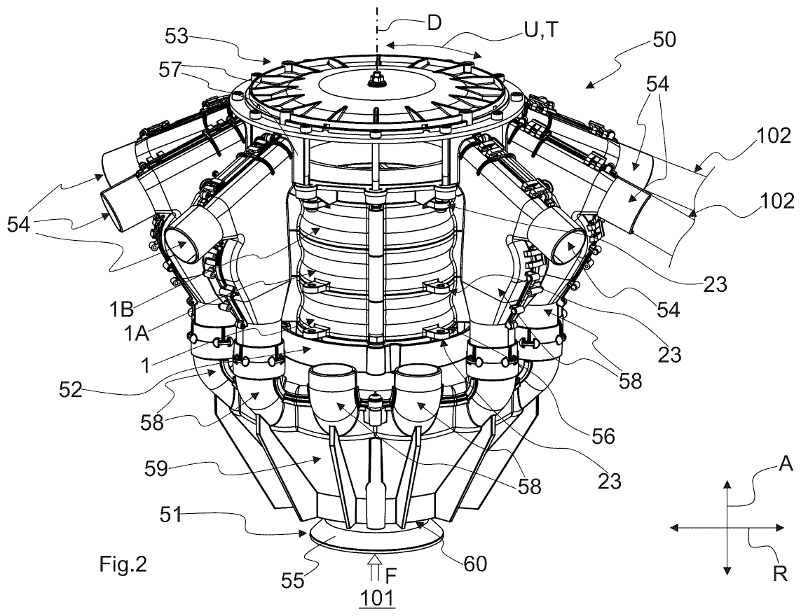

Here, the agricultural spreading machine 100 comprises a distributor head 50, which is described in more detail in FIGS. 2 to 5, and a plurality of spreading lines 102 for conveying granular material to an agricultural area. For example, each spreading line 102 connects an output channel 54 of the distributor head 50 to a depositing device 103 of the spreading machine 100.

Further, the spreading machine 100 has a plurality of depositing devices 103. The depositing devices 103 are each connected to a spreading line 102 (not shown) and are adapted to deposit a conveyed material flow F, comprising granular material and air, onto an agricultural utilizable area.

In even more detail, FIG. 1 shows a machine group 200 with an agricultural towing vehicle 201 configured as a tractor and an agricultural spreading machine 100 configured as a sowing machine.

In the embodiment shown, the agricultural spreading machine 100 is configured as a towed machine. In other embodiments, the agricultural spreading machine 100 may also be configured as a supported machine, so that the agricultural towing vehicle 201 acts as a carrier vehicle.

Furthermore, FIG. 1 shows that the agricultural spreading machine 100 comprises a storage container 104 for storing granular material, for example seed and/or fertilizer. The granular material stored in the storage container 104 is fed to a distributor head 50 via a supply line 101.

The distributor head 50 distributes the granular material to a plurality of spreading lines 102 (not shown in FIG. 1), wherein the spreading lines 102—as already mentioned—are connected to depositing devices 103 of the agricultural spreading machine 100.

The granular material is deposited onto an agricultural area via the depositing devices 103. The depositing devices 103 can be, for example, sowing coulters. Furthermore, the depositing devices 103 are arranged on a machine frame 106 of the agricultural spreading machine 100. Soil cultivation tools 105, 107 are also attached to the machine frame 106.

Described in more detail, the agricultural spreading machine 100 comprises several transverse rows of leading soil cultivation tools 105, which are arranged in front of the depositing devices 103 in the direction of travel. Furthermore, the agricultural spreading machine 100 comprises several transverse rows of trailing soil cultivation tools 107, which are arranged behind the depositing devices 103 in the direction of travel.

FIGS. 2 to 5 all show the same distributor head 50 in different representations.

For example, FIG. 2 shows a perspective view of a distributor head 50 of the spreading machine 100 of FIG. 1, in which return devices 58 have been masked out in order to be able to see flow devices 1, 1A, 1B behind it.

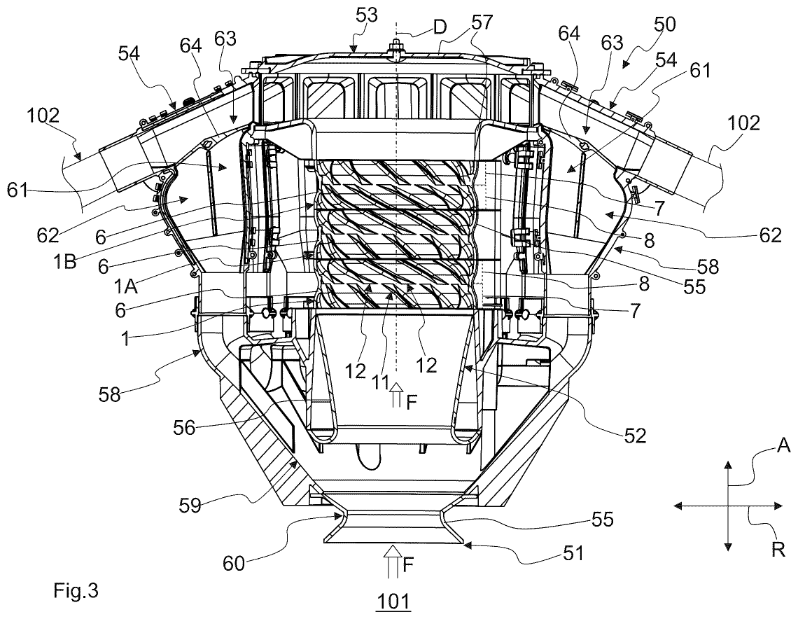

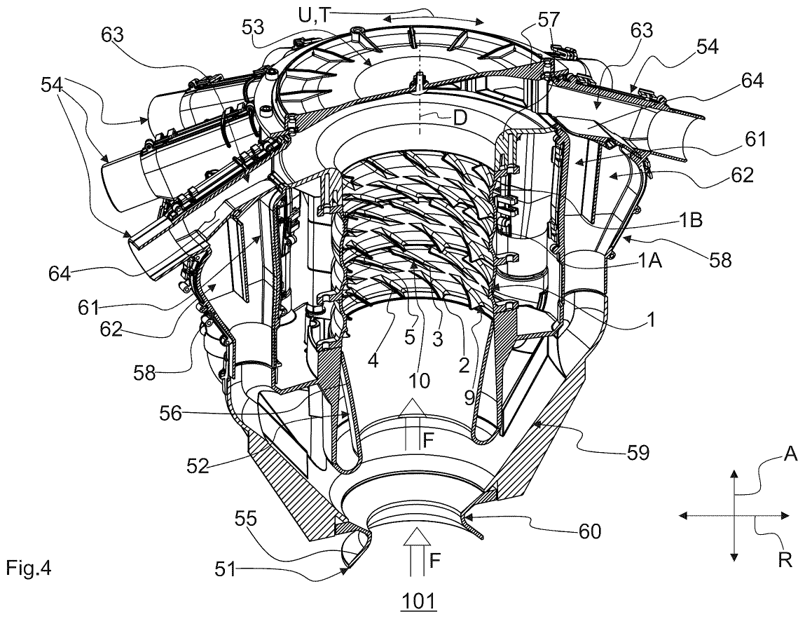

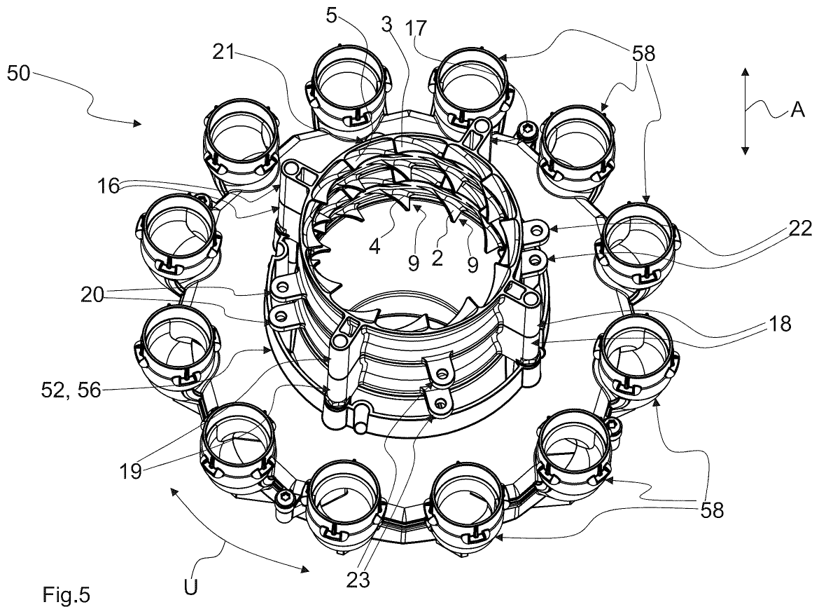

FIG. 3 shows a sectional view of the distributor head 50 from FIG. 2 and FIG. 4 shows a perspective view of the sectional view from FIG. 3. FIG. 5 shows a partial perspective view of the distributor head 50 of FIG. 2.

For the sake of simplicity and brevity, FIGS. 2 to 5 are described together below.

FIGS. 2 to 5 thus show a distributor head 50 for an agricultural spreading machine 100 and for distributing granular material to a plurality of spreading lines 102.

The distributor head 50 has an inlet device 51 for connection to a supply line 101 of an agricultural spreading machine 100 (see FIGS. 2 and 3), wherein a conveyed material flow F comprising air and granular material can be introduced through the supply line 101 and thus also through the inlet device 51 into the distributor head 50 or into a main conveyor 52 of the distributor head 50.

Here, the inlet device 51 comprises a constriction 60 configured as a nozzle. Furthermore, the supply line 101 is pneumatically pressurized in order to form the conveyed material flow F.

In addition, the distributor head 50 has a main conveyor 52 for further conveying the conveyed material flow F from the inlet device 51 to a distribution device 53 of the distributor head 50.

Furthermore, the distributor head 50 comprises a distribution device 53 for distributing and/or forwarding the conveyed material flow F into output channels 54 of the distributor head 50. Thus, output channels 54 extending from the distribution device 53 can introduce the conveyed material flow F into spreading lines 102 leading to depositing devices 103.

FIGS. 2 to 5 further show that the distribution device 53, the main conveyor 52 and the inlet device 51 are connected in series in axial direction A. In this case, the conveyed material flow F also flows through the distribution device 53, the main conveyor 52 and the inlet device 51 in axial direction A.

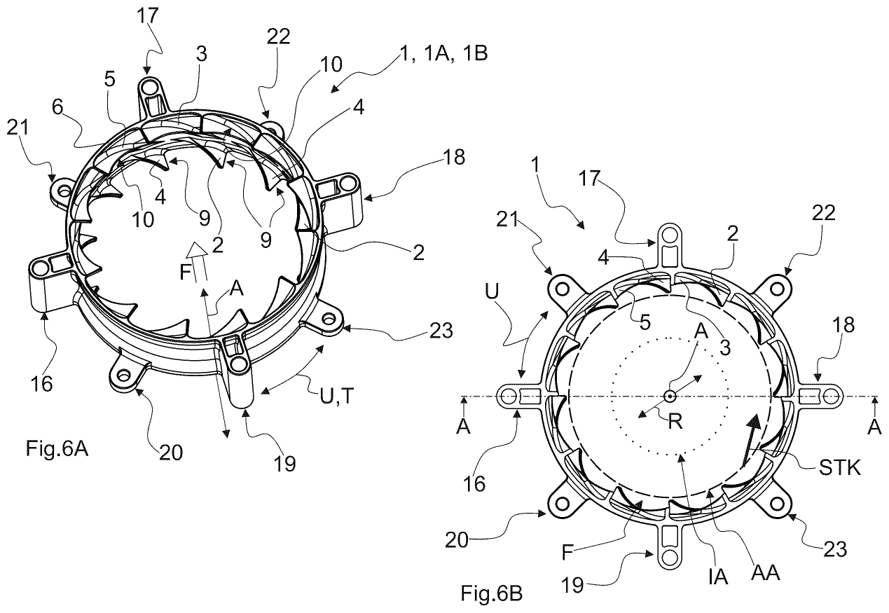

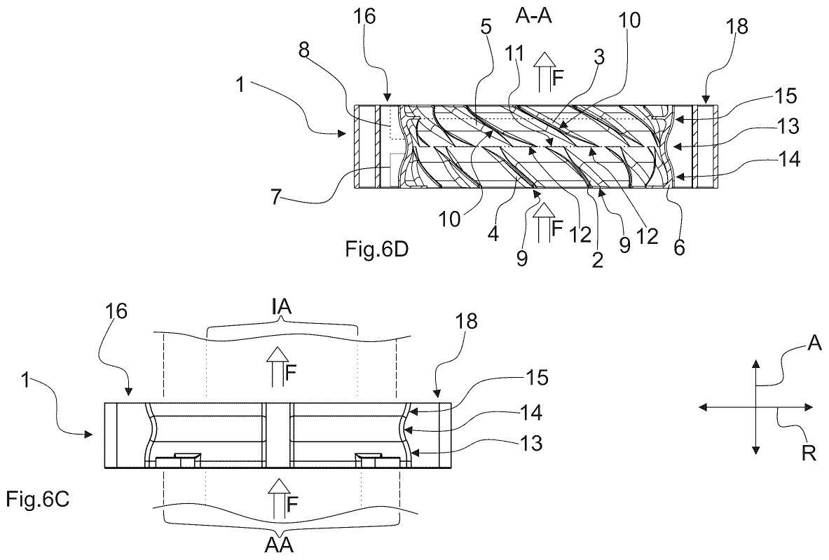

FIGS. 2 to 5 also show that the distributor head 50 comprises a plurality of flow devices 1, 1A, 1B for at least partially guiding the conveyed material flow F. The flow devices 1, 1A, 1B can be used to generate an at least partially helical or an at least partially rotating conveyed material flow F. With regard to the exact possible configurations of a flow device 1, 1A, 1B, reference is made to the various embodiments and the associated explanations in FIGS. 6A to 8B.

In FIGS. 2 to 5, the flow devices 1, 1A, 1B are arranged on the main conveyor 52 and form it further or continue it. Here, the main conveyor 52 is configured similar to a diffuser and the flow devices 1, 1A, 1B, strictly speaking, attach to a wall 56 of the main conveyor 52 or continue the wall 56 of the main conveyor 52 (see FIGS. 3 and 4).

Furthermore, the flow devices 1, 1A, 1B are arranged downstream of the main conveyor 52.

In other words, the flow devices 1, 1A, 1B are arranged upstream of the distribution device 53, wherein the flow device 1 forms or continues at least a part of the distribution device 53 or a part of a wall 57 of the distribution device 53.

According to FIGS. 2 to 5, the flow devices 1, 1A, 1B are configured to be rigid or immovable.

However, it is also possible that they are configured to be movable or rotatable relative to the distribution device 53. In such a case, the flow devices 1, 1A, 1B could be configured to be rotatable relative to an axis D, which is aligned parallel to the conveyed material flow F or to the axial direction A of the flow devices 1, 1A, 1B or of the distributor head 50. By means of the mobility or rotation of the flow device 1, 1A, 1B, for example, the formation or intensity of the at least partially helical or at least partially rotating conveyed material flow F can be adjusted in a simple manner.

According to FIGS. 2 to 5, the distributor head 50 comprises three flow devices 1, 1A, 1B, which are arranged one behind the other in the conveyed material flow F or in the axial direction A of the distributor head 50 and together form or continue the main conveyor 52.

In this case, a first and second flow device 1, 1A are arranged in the same orientation to one another, a third flow device 1B being oriented upside down in comparison to the first and second flow device 1, 1A and arranged on the second flow device 1A (see FIGS. 2 and 3 in connection with connecting sections 23 of the flow device 1, 1A, 1B).

In addition, FIGS. 2 and 4 show that the distributor head 50 comprises a plurality of output channels 54 which extend from the distribution device 53 and via which the conveyed material flow F can be introduced into spreading lines 102 leading to depositing devices 103. The output channels 54 extend in the radial direction R from the distributor head 50.

In addition, according to FIGS. 2 to 5, the distributor head 50 has a plurality of return devices 58, by means of which the conveyed material flow F can be returned from an output channel 54 to the main conveyor 52.

Furthermore, FIGS. 2 to 4 show that the distributor head 50 comprises a circumferential return collecting area 59, which is connected to the main conveyor 52 and into which all return devices 58 open.

The return collecting area 59 is arranged between the main conveyor 52 and the inlet device 51 or downstream of the inlet device 51. In the event that a flow device 1 would be arranged upstream of the inlet device 51, an at least partially rotating or an at least partially helical conveyed material flow can be generated before the conveyed material flow F enters the main conveyor 52. This makes it possible to avoid accumulations of granular material in the return collecting area 59 and thus within the distributor head 50 for the agricultural spreading machine 100 and for distributing granular material when the distributor head 50 is inclined on an inclined utilizable area. Thus, granular material can be easily picked up from the return collecting area 59 and conveyed back in the direction of the distribution device 53.

Referring to FIGS. 3 and 4, the material return flow areas 58 each comprise a material return flow area 61 and an air discharge flow area 62. Through the material return flow area 61, the conveyed material flow F or the granular material contained therein can be returned from an output channel 54 to the main conveyor 52 via a return flow. Air separated from the return flow can be fed through the air discharge flow area 62 to an output channel 54 or a spreading line 102.

Furthermore, FIGS. 3 and 4 show that the distributor head 50 comprises a plurality of deflecting devices 63, each of which can be brought into a through-passage position or a return position. Of course, positions of the deflecting devices 63 or of a deflecting device 63 between the through-passage position and the return position can also be realized.

Each deflecting device 63 is arranged within a return device 58, so that in the through-passage position the conveyed material flow F can be guided into an output channel 54 of the distributor head 50 and in the return position it can be guided into a material return flow area 61 of a return device 58.

Furthermore, each deflecting device 63 has a movable deflecting body 64. For example, the movable deflecting bodies 64 of the deflecting devices 63 are arranged to block a passage from the output channel 54 into the material return flow area 61 in the through-passage position. At the same time, as can be seen in FIG. 4, the deflecting bodies 64 of the deflecting devices 63 are also set up to reduce or close the free flow cross-section in the passage from the output channel 54 into the air discharge flow area 62 in the through-passage position. Thus, the flow rate from an output channel 54 to a spreading line 102 can be variably adjusted.

In addition, for example, each movable deflecting body 64 of the deflecting devices 63 is set up to release the passage from the output channel 54 into the material return flow area 61 in the return position.

Any positions of a deflecting body 64 between the through-passage position and the return position are also conceivable.

As soon as the movable deflecting body 64 allows passage into the material return flow area 61, the complete conveyed material flow F or only a part thereof flows via the material return flow area 61 into the return collecting area 59. Thus, the complete conveyed material flow F or only a part thereof is directed back upstream of the main conveyor 52 to the conveyed material flow F flowing into the inlet device 51 of the distributor head 50 from a connected supply line 101.

Accordingly, the distributor head 50 is equipped with the deflecting devices 63 to temporarily interrupt, by means of the deflecting devices 63, the introduction of granular material or the conveyed material flow F into the spreading lines 102 leading to the depositing devices 103. This allows the spreading of the granular material onto the agricultural area to be temporarily interrupted row-specifically, area-specifically or over the entire width of the agricultural spreading machine 100.

FIGS. 6A-6D show four different views of a first embodiment of a flow device 1 for at least partially guiding a conveyed material flow F within the distributor head 50 of FIGS. 2 to 5. The following description also applies in an analogous manner to the flow devices 1A and 1B, as shown in FIGS. 2 to 5 with respect to the distributor head 50.

Described in more detail, FIG. 6A shows a perspective view, FIG. 6B a top view, FIG. 6C a side view and FIG. 6D a sectional view along line A-A from FIG. 6B. For the sake of simplicity and brevity, FIGS. 6A-6D are described together.

Thus, as already mentioned, FIGS. 6A-6D show a flow device 1 for at least partially guiding a conveyed material flow F within a distributor head 50 of an agricultural spreading machine 100.

The flow device 1 is configured to generate an at least partially rotating or an at least partially helical conveyed material flow F. As already mentioned in connection with the distributor head 50 with regard to FIGS. 2 to 5, a conveyed material flow F comprises air and granular material.

The flow device 1 is also configured to generate an at least partially rotating or an at least partially helical conveyed material flow from a conveyed material flow F flowing in the axial direction A. In other words, the flow device 1 is configured to at least partially set in rotation a conveyed material flow F flowing in the axial direction A. As a result, the conveyed material flow F continues to flow in the axial direction A, but also rotates. The flow device 1 thus converts a conveyed material flow F flowing in the axial direction A into an at least partially rotating or an at least partially helical conveyed material flow F. To put it in yet other words, the flow device 1 is configured to generate at least in part a swirling flow from a conveyed material flow flowing in the axial direction A.

As illustrated in FIGS. 6B and 6C, the flow device 1 extends in the axial direction A, in the radial direction R and in the circumferential direction U or in the tangential direction T, to form a spatial body. The conveyed material flow F flows in the axial direction A through the flow device 1.

Furthermore, the flow device 1 divides the conveyed material flow F into an inner section IA and an outer section AA. The outer section AA completely surrounds the inner section IA, so that the outer section AA contacts or interacts with the flow device 1 and the inner section IA contacts or interacts with the outer section AA.

Thus, according to FIGS. 6B and 6C, the outer section AA forms a hollow cylindrical shape and the inner section IA forms a cylindrical shape, with the inner cylindrical section IA completely filling the outer hollow cylindrical section AA. As a result, the flow device 1 contacts the outer section AA and the inner section IA contacts the outer section AA. The interaction between flow device 1 and conveyed material flow F and between flow device 1 and an outer section AA of the conveyed material flow F allows an at least partially rotating conveyed material flow F to be generated. It allows the avoidance of accumulations of granular material, which may arise on an inclined usable area when the distributor head 50 is inclined, within the distributor head 50.

Furthermore, FIGS. 6A-6D show that the flow device 1 comprises a plurality of flow guides 2, 3, 4, 5 for generating an at least partially rotating or at least partially helical conveyed material flow F.

The function of the flow guides 2, 3, 4, 5 is to at least partially redirect the conveyed material flow F and to redirect at least the outer section AA of the conveyed material flow F and to set it in rotation (see FIGS. 6B, 6C).

The flow guides 2, 3, 4, 5 are configured to act on the conveyed material flow F from the outside in order to add a movement component STK in the tangential direction T and in the radial direction R to at least the outer section AA of the conveyed material flow F, which completely surrounds an inner section IA of the conveyed material flow F. This allows an at least partially helical or rotating conveyed material flow F to be generated.

In the present embodiment, the flow guides 2, 3, 4, 5 are configured to be rigid or immobile. However, it is possible that these are adjustable in order to take into account different flow velocities or different characteristics of the conveyed material flow F and to generate an at least partially helical or rotating conveyed material flow F.

Furthermore, the flow guides 2, 3, 4, 5 comprise a plastic. However, it is also conceivable that these comprise an elastic material, such as, for example, elastomer, and/or steel, such as, for example, stainless steel, in order, for example, to minimize wear when using a fertilizer as a granular material.

Furthermore, according to FIGS. 6A to 6D, the flow device 1 is configured in such a way that a conveyed material flow F can be introduced into the flow device 1 in axial direction A and that the flow device 1 can be flowed through by the conveyed material flow F and can be flowed against by the conveyed material flow F in axial direction A.

As can also be seen from FIGS. 6A-6D, the flow device 1 comprises a wall 6, which serves as a continuation or further development of the main conveyor 52 of the distribution head 50 (see FIGS. 2 to 5).

The wall 6 is configured in the shape of a tube or hollow cylinder. Furthermore, the wall 6 is configured in the shape of a wave in a cross-section along the direction in which the conveyed material flow F flows through the flow device 1 (see FIGS. 6C, 6D). More precisely, the wall 6 comprises a valley area 13 and two hill areas 14, 15 in a cross-section along the direction in which the conveyed material flow F flows through the flow device 1 or along the axial direction A of the flow device 1, which merge smoothly into one another, e.g. to simulate a so-called corrugated tube.

According to FIGS. 6A-6D, a flow guide 2, 3, 4, 5 is configured similar to a guide vane or similar to a guide plate. As a result, an at least partially rotating or an at least partially helical conveyed material flow F can be formed or generated. While a guide vane is known in connection with a jet engine, a guide plate is known for changing the direction of a flow. Accordingly, the flow guides 2, 3, 4, 5 are configured as flow bodies to be flowed around in order to form an at least partially rotating or helical conveyed material flow F.

According to FIGS. 6A to 6D, the flow guides 2, 3, 4, 5 are fixedly arranged on the wall 6 of the flow device 1. However, it is also conceivable that the flow guides 2, 3, 4, 5 are arranged adjustably or variably on the wall 6 of the flow device 1. For example, the flow guides 2, 3, 4, 5 could be configured to rotate relative to the wall 6 of the flow device 1. This allows different configurations of a rotating or helical conveyed material flow F.

As can also be clearly seen in FIGS. 6A and 6B, the flow guides 2, 3, 4, 5 are configured in a triangular shape similar to a spherical triangle. It can also be seen that the flow guides 2, 3, 4, 5 are configured differently and comprise a first and a second flow guide.

The first flow guide 2, 4 and the second flow guide 3, 5 comprise different volumes. Furthermore, the first flow guide 2, 4 and the second flow guide 3, 5 have differently shaped surfaces and different angles of attack in relation to the conveyed material flow F.

Furthermore, the first flow guide 2, 4 and the second flow guide 3, 5 are arranged one behind the other in the direction of the conveyed material flow F. The two flow guides 2, 3, 4, 5 arranged one behind the other in the direction of the conveyed material flow Fare aligned with respect to each other in such a way that, viewed in the direction of the conveyed material flow F, the first flow guide 2, 4 and the second flow guide 3, 5 partially overlap (see FIGS. 6A and 6B). In addition, the first flow guide 2, 4 and the second flow guide 3, 5 are mirror-inverted with respect to each other.

Furthermore, two flow guides 2, 3, 4, 5 arranged one behind the other in the direction of the conveyed material flow F are aligned with respect to each other in such a way that an edge 9 or a first edge 9 of the first flow guide 2, 4 is the shortest edge of the flow guide 2, 4. The first edge 9 of the first flow guide 2, 4 is aligned at an angle of between 81 and 99 degrees to the wall 6 of the flow device 1.

A second edge 10 of the second flow guide 3, 5 or a flowed-on edge 10 of the second flow guide 3, 5 is aligned at an angle of between 15 and 40 degrees to the wall 6 of the flow device 1. The flow guide 3, 5 rises continuously from the wall 6 or extends away from the wall 6 in the direction F of the conveyed material (see FIG. 6A).

According to FIG. 6D, the flow device 1 comprises a first and a second ring 7, 8 of flow guides 2, 3, 4, 5. The first and second rings 7, 8 are configured in a cylindrical shape and each comprise a plurality of flow guides 2, 3, 4, 5, which are equally distributed in the circumferential direction U of the rings 7, 8 and are aligned in the same spatial orientation.

The first ring 7 comprises the first flow guides 2, 4 and the second ring 8 comprises the second flow guides 3, 5, the first and second rings 7, 8 being arranged one behind the other in the direction of the conveyed material flow F.

FIG. 6D also shows that the first and second rings 7, 8 are arranged offset to each other. Specifically, the first and second rings 7, 8 are arranged offset relative to one another such that the end 11 of a first flow guide 2, 4 of the first ring 7 arranged in the direction of the conveyed material flow F is arranged between two beginnings 12 of two second flow guides 3, 5 of the second ring 8.

FIGS. 2 to 5, but also FIGS. 6A to 6D, also show that the flow device 1 is configured in a modular manner, so that several flow devices 1, 1A, 1B—as shown in FIGS. 2 to 5—are connectable to one another.

For this purpose, the flow device 1 comprises various connecting sections 16, 17, 18, 19 (see FIGS. 6A to 6D), at which two flow devices 1, 1A, 1B are force-fit connectable or connected to each other. The connecting sections 16, 17, 18, 19 are equally distributed in the circumferential direction U of the flow device 1.

In addition, FIGS. 6A to 6D show that the flow device 1 also comprises a plurality of connecting sections 20, 21, 22, 23 at which the flow device 1 is force-fit connectable to the wall 56 of the main conveyor 52 of the distribution head 50 (see also FIGS. 2 to 5).

With reference to FIGS. 2 to 5, the functioning of the distributor head 50 with the flow devices 1, 1A, 1B is explained below.

After the conveyed material flow F has flown from the supply line 101 into the inlet device 51, the conveyed material flow F reaches the main conveyor 52.

Due to the configuration of the main conveyor 52 in the form of a diffuser, the speed of the conveyed material flow F is reduced, but the pressure is increased.

By reducing the speed of the conveyed material flow F, the flow devices 1, 1A, 1B connected in series comprise an improved efficiency.

If the conveyed material flow F now enters the flow devices 1, 1A, 1B from the main conveyor 52, the conveyed material flow F is symbolically divided into two sections; namely an inner section IA and an outer section AA (see FIGS. 6B, 6D). The outer section AA surrounds the inner section IA, as already described, so that the outer section AA contacts the flow device 1 and the inner section IA contacts the outer section AA. In this case, the outer section AA forms a hollow cylindrical shape and the inner section IA forms a cylindrical shape. In other words, the outer section AA is influenced by the flow guides 2, 3, 4, 5 in such a way that a flow component STK in the tangential direction T and in the radial direction R is added to the conveyed material flow F in the outer section AA. The conveyed material flow F in the inner section AA can be influenced by the flow devices 1, 1A, 1B from the conveyed material flow F in the outer section AA.

As a result, an at least partially rotating or an at least partially helical conveyed material flow F is generated by means of the flow devices 1, 1A, 1B.

This rotating or helical conveyed material flow F enters the distribution device 53 from the flow devices 1, 1A, 1B. The distribution device 53 distributes the conveyed material flow F to the output channels 54.

If, for example, the agricultural spreading machine 100 is now moved on a plane that is inclined transversely to the direction of travel of the agricultural towing vehicle 201 (see FIG. 1), the distributor head 50 is also inclined; for example, with reference to FIG. 3, counterclockwise.

Due to this situation, more granular material of the conveyed material flow F reaches the left side of the distribution device 53 due to the acting force of gravity.

However, the rotating or helical conveyed material flow F, which flows from the flow devices 1, 1A, 1B into the distribution device 53, prevents a build-up of granular material of the conveyed material flow F. Thus, a constant uniform distribution of the conveyed material flow F or the granular material can also be ensured on an inclined plane or on an inclined agricultural utilizable area within the distribution device 53.

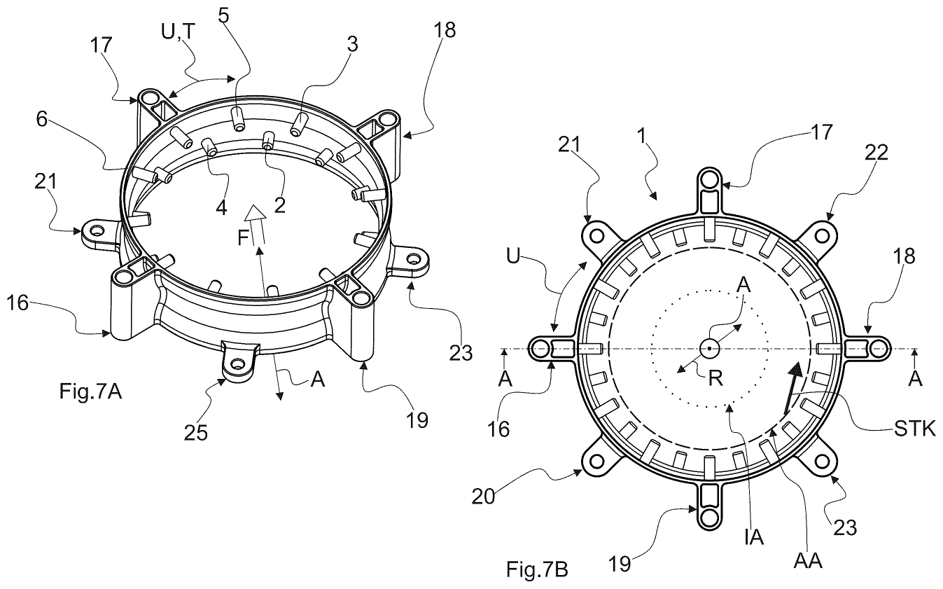

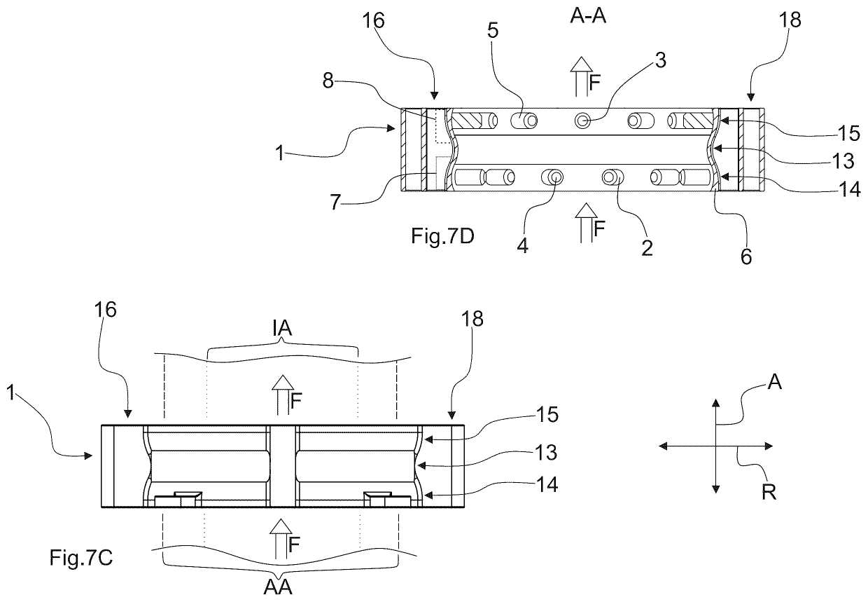

FIGS. 7A-7D show four different views of a second embodiment of a flow device 1 for at least partially guiding a conveyed material flow F within the distributor head 50 of FIG. 2. The views are analogous to FIGS. 6A-6D.

More specifically, FIG. 7A shows a perspective view, 7B a top view, 7C a side view and 7D a sectional view along line A-A from FIG. 7B. For the sake of simplicity and brevity, FIGS. 7A-7D are described together.

Thus, FIGS. 7A-7D show a flow device 1 for at least partially guiding a conveyed material flow F within a distributor head 50 of an agricultural spreading machine 100.

Here, the flow device 1 is configured to generate an at least partially rotating or an at least partially helical conveyed material flow F. In other words, the flow device 1 is configured to cause a conveyed material flow F to rotate at least partially.

To avoid unnecessary repetition, reference is made to the explanations relating to the first embodiment, which are applicable analogously here. The differences between the first and second embodiments are discussed below.

When comparing FIGS. 6A-6D with FIGS. 7A-7D, it is noticeable that in the second embodiment according to FIGS. 7A-7D, the flow guides 2, 3, 4, 5 are not configured similar to a guide vane or similar to a guide plate, but as a pin.

Thus, in FIGS. 7A to 7D, the flow guides 2, 3, 4, 5 are configured as cylindrical pins for guiding the conveyed material flow F in order to thereby form an at least partially rotating or at least partially helical conveyed material flow F. Alternatively, it is also possible that the flow guides 2, 3, 4, 5 configured as pins are frustoconical.

FIGS. 7A-7D show that the flow guides 2, 3, 4, 5 protrude from the wall 6 of the flow device 1 and form an angle of 90 degrees to the surface of the wall 6. However, an angle in the range between 80 and 100 degrees is also possible.

Furthermore, it can be seen from FIGS. 7A-7D that the first and second rings 7, 8 are arranged offset to one another in such a way that a first flow guide 2, 4 of the first ring 7 is arranged in the direction of the conveyed material flow F between two second flow guides 3, 5 of the second ring 8.

The functioning of the distributor head 50 with a flow device 1 according to FIGS. 7A to 7D is analogous to the flow device 1 of FIGS. 6A to 6D.

That is, by means of the flow device 1 according to FIGS. 7A to 7D, a rotating or helical conveyed material flow F enters the distribution device 53. The distribution device 53 distributes the conveyed material flow F to the output channels 54.

If, for example, the agricultural spreading machine 100 is now moved on a plane that is inclined transversely to the direction of travel of the agricultural towing vehicle 201 (see FIG. 1), the distributor head 50 is also inclined; for example, with reference to FIG. 3, counterclockwise. As a result, more granular material of the conveyed material flow F reaches the left side of the distribution device 53 due to the acting force of gravity.

The rotating or helical conveyed material flow F, which flows into the distribution device 53, prevents a build-up of granular material of the conveyed material flow F. Thus, a constant uniform distribution of the conveyed material flow For the granular material can also be achieved on an inclined plane or on an inclined agricultural utilizable area within the distribution device 53.

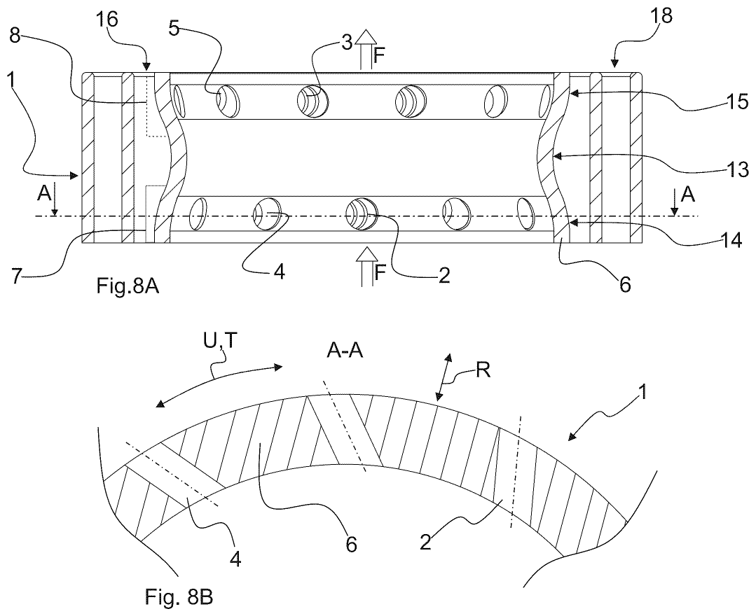

FIGS. 8A and 8B show two views of a third embodiment of a flow device 1 for at least partially guiding a conveyed material flow F within the distributor head 50 of FIG. 2. While the view from FIG. 8A is analogous to FIGS. 6D and 7D, FIG. 8B shows a section of a cut along the line A-A of FIG. 8A. For the sake of simplicity and brevity, FIGS. 8A and 8B are described together.

Thus, these show a flow device 1 for at least partially guiding a conveyed material flow F within a distributor head 50 of an agricultural spreading machine 100.

The flow device 1 is configured to generate an at least partially rotating or an at least partially helical conveyed material flow F. In other words, the flow device 1 is configured to cause a conveyed material flow F to rotate at least partially.

To avoid unnecessary repetition, reference is made to the explanations concerning the first embodiment, which are applicable here by analogy. The differences between the first and third embodiments are discussed below.

When comparing FIGS. 6A-6D with FIGS. 8A-8B, it is noticeable that in the third embodiment according to FIGS. 8A-8B, the flow guides 2, 3, 4, 5 are not configured similar to a guide vane or similar to a guide plate, but as a fluid channel. Accordingly, the flow guides 2, 3, 4, 5 are configured as flow sections to be flown through in order to form an at least partially rotating or helical conveyed material flow F.

FIGS. 8A and 8B show that the flow guides 2, 3, 4, 5 are configured as fluid channels within the wall 6 of the flow device 1 in order to form an at least partially rotating or at least partially helical conveyed material flow F.

Furthermore, according to FIG. 8A, the flow guides 2, 3, 4, 5 are arranged within the walls 6 of the flow device 1 in order to add a movement component STK or flow component STK in the tangential direction T and in the radial direction R to the conveyed material flow F by means of an air stream flowing through the flow guides 2, 3, 4, 5.

A flow component STK can be added in two different ways. For example, an air flow can be removed from the conveyed material flow F through the flow guides 2, 3, 4, 5 configured as fluid channels, for example by suction, or an air flow can be added to the conveyed material flow F through the flow guides 2, 3, 4, 5 configured as fluid channels, for example by blowing.

As shown in FIG. 8B, each flow guide 2, 3, 4, 5 extends along a rectilinear axis, wherein each flow guide 2, 3, 4, 5 is arranged within the wall 6 at an angle to the conveyed material flow F.

More specifically, each flow guide 2, 3, 4, 5 is arranged within the wall 6 running in tangential direction T and radial direction R. In this case, the flow guides 2, 3, 4, 5 form an angle of less than 90 degrees or an angle in the range between 20 and 60 degrees to the surface of the wall 6. This angle allows the optimum formation of an at least partially rotating or at least partially helical conveyed material flow F.

Furthermore, it can be seen from FIGS. 8A and 8B that the first and second rings 7, 8 are arranged offset with respect to each other in such a way that a first flow guide 2, 4 of the first ring 7 is arranged in the direction of the conveyed material flow F between two second flow guides 3, 5 of the second ring 8.

The functioning of the distributor head 50 with a flow device 1 according to FIGS. 8A and 8B is analogous to the flow device 1 from FIGS. 6A to 6D.

Consequently, by means of the flow device 1, a rotating or helical conveyed material flow F enters the distribution device 53, which distributes the conveyed material flow F to the output channels 54.

If, for example, the agricultural spreading machine 100 is now moved on a plane that is inclined transversely to the direction of travel of the agricultural towing vehicle 201 (see FIG. 1), the distributor head 50 is also inclined; for example, with reference to FIG. 3, counterclockwise. Thus, due to the acting gravity, more granular material of the conveyed material flow F reaches the left side of the distribution device 53.

The rotating or helical conveyed material flow F, which flows into the distribution device 53, prevents the granular material of the conveyed material flow F from accumulating. As a result, a constant uniform distribution of the conveyed material flow F or the granular material can also be achieved on an inclined plane or on an inclined agricultural utilizable area within the distribution device 53.

### REFERENCE SIGNS

1 flow device
1A flow device
1B flow device
2 flow guide
3 flow guide
4 flow guide
5 flow guide
6 wall of a flow guide
7 first ring
8 second ring
9 first edge
10 second edge
11 end of a flow guide
12 beginning of a flow guide
13 valley area
14 hill area
15 hill area
16 connecting section
17 connecting section
18 connecting section
19 connecting section
20 connecting section
21 connecting section
22 connecting section
23 connecting section
50 distributor head
51 inlet device
52 main conveyor
53 distribution device
54 output channel
55 wall of the inlet device
56 wall of the main conveyor
57 wall of the distribution device
58 return devices
60 constriction
61 material return flow area
62 air discharge flow area
63 deflecting device
64 deflecting body
100 agricultural spreading machine
101 supply line
102 spreading lines
103 depositing devices
104 storage container
105 soil cultivation tools
106 machine frame
107 soil cultivation tools
200 machine group
201 agricultural towing vehicle
F conveyed material flow
AA outer section of the conveyed material flow
IA inner section of the conveyed material flow
STK flow component in the tangential direction
A axial direction
R radial direction
T tangential direction
U circumferential direction
D axis parallel to the conveyed material flow

1. A flow device for at least partially guiding a flow of conveyed material within a distributor head of an agricultural spreading machine, wherein the flow device is configured to generate an at least partially rotating or an at least partially helical flow of conveyed material.

2. The flow device according to claim 1,
wherein the flow device comprises at least one flow guide for generating an at least partially rotating or at least partially helical conveyed material flow, and
wherein the at least one flow guide is configured to act from outside on a conveyed material flow in order to add a movement component or flow component in tangential direction and/or in radial direction and/or in axial direction to at least one outer section of the conveyed material flow, which completely surrounds an inner section of the conveyed material flow.

3. The flow device according to claim 1,
wherein the flow device. comprises at least one flow guide for generating an at least partially rotating or at least partially helical conveyed material flow, and
wherein the at least one flow guide is configured to be adjustable in order to take into account different flow velocities and/or different characteristics of a conveyed material flow

4. The flow device according to claim 1,
wherein the flow device comprises at least one flow guide for generating an at least partially rotating or at least partially helical conveyed material flow, and
wherein the at least one flow guide is configured similar to a guide vane or similar to a guide plate.

5. The flow device according to claim 1,
wherein the flow device comprises at least one flow guide for generating an at least partially rotating or at least partially helical conveyed material flow,
wherein the at least one flow guide is configured as a pin for guiding a conveyed material flow.

6. The flow device according to claim 1,
wherein the flow device comprises at least one flow guide for generating an at least partially rotating or at least partially helical conveyed material flow,
wherein the at least one flow guide is configured as a fluid channel within a wall of the flow device.

7. The flow device according to claim 6,
wherein the at least one flow guide is arranged within a wall of the flow device in order to add a movement component or flow component in tangential direction and/or in radial direction and/or in axial direction to the conveyed material flow by means of an air flow which flows through the at least one flow guide.

8. The flow device according to clam 1,
wherein the flow device comprises a first and/or a second ring of flow guides,
wherein the first ring comprises at least one first flow guide, and the second ring comprises at least one second flow guide, and
wherein the first and second ring are arranged offset to each other in such a way that the end of a first flow guide of the first ring arranged in direction of a conveyed material flow is arranged between two beginnings of two second flow guides of the second ring.

9. The flow device according to claim 1,
wherein the flow device is configured in a modular manner so that at least two flow devices are connectable or detachable to each other, and
wherein the flow device comprises at least one connecting section at which two flow devices are connectable to one another in a material-fit and/or friction-fit and/or force-fit manner.

10. The flow device according to claim 1,
wherein the flow device comprises at least one connecting section, at which the flow device is connectable in a material- and/or friction- and/or force-fit manner to a wall of a main conveyor of a distribution head of an agricultural spreading machine and/or to a wall of an inlet device of a distribution head of an agricultural spreading machine and/or to a wall of a distribution device of a distribution head of an agricultural spreading machine.

11. A distributor head for an agricultural spreading machine and for distributing granular material to a plurality of spreading lines, comprising
an inlet device for connection to a supply line of an agricultural spreading machine,
wherein a conveyed material flow comprising air and granular material can be introduced into the distributor head through the inlet device,
a main conveyor for further conveying the conveyed material flow from the inlet device to a distribution device of the distributor head, and
a distribution device for distributing and/or forwarding the conveyed material flow into output channels of the distributor head, wherein
the distributor head comprises at least one flow device for at least partially guiding the conveyed material flow according to one of the preceding claims.

12. The distributor head according to claim 11,
wherein the at least one flow device is arranged at the main conveyor and further forms and/or continues the main conveyor, and/or
wherein the at least one flow device is arranged at the inlet device and is arranged downstream and/or upstream of the inlet device, and/or
wherein the at least one flow device is arranged at the distribution device and is arranged upstream of the distribution device.

13. The distributor head according to claim 11,
wherein the at least one flow device is configured to be immovable or movable, and/or
wherein the at least one flow device is configured to be rotatable relative to the distribution device and/or to the main conveyor and/or to the inlet device.

14. An agricultural spreading machine, comprising
a distributor head according to claim 11.
